(19) United States
(12) Patent Application Publication
(10) Pub. No.: US 2011/0224872 A1
(43) Pub. Date: Sep. 15, 2011

(54) System And Method To Control Vehicle Steering

(75) Inventor: David Reed, Everett, WA (US)

(73) Assignee: GENIE INDUSTRIES, INC., Redmond, WA (US)

(21) Appl. No.: 12/720,701

(22) Filed: Mar. 10, 2010

(51) Int. Cl. G06F 19/00

(52) U.S. Cl. 701/41

(57) ABSTRACT

A vehicle controlled via a joystick has a turn request mode and a return to center request. While the operator is requesting a turn, steered wheels are turned at a predetermined rate, steering angle continuing to change while the turn request is being applied. When the operator ceases requesting a turn, the return to center mode is invoked: a direction of a virtual wheel of the vehicle is determined and such direction is maintained. A vehicle angular velocity is computed based on vehicle velocity and a virtual steering angle, which is the angle between the direction the virtual wheel is pointing and the longitudinal axis of the vehicle. To maintain the direction of the virtual wheel during a return to center, the virtual wheel is turned at an angular velocity equal in magnitude to the angular velocity of the vehicle and in a direction to return to center.

### BACKGROUND

1. Technical Field

The present development relates to a method and system for controlling steered wheels of a vehicle based on signals from an operator-input device.

2. Background Art

Industrial vehicles, such as aerial work platforms and scissor lifts, are driven under operator-control into a desired location for performing aerial work or raising equipment. Vehicle movement to attain the desired location is controlled via a joystick, or other operator-input device. A turn is requested by pushing a joystick, or other operator actuator, to the right or left. When the operator stops calling for a turn by allowing the joystick to return to the center position, the steering angles of the steered wheels are held in the turning position. To straighten out the vehicle, the operator pushes the joystick in the opposite direction in an attempt to return the wheels to center. If the steered wheels are in the operator's line of sight, the operator can base the joystick control on such view.

It is difficult, even with a line of sight, to straighten the wheels perfectly. Instead, the joystick is typically dithered between the left and right positions multiple times to satisfactorily straighten the wheels. This can be frustrating to even an experienced vehicle operator as it can be difficult to align the vehicle as accurately as desired. This is particularly difficult when the steered wheels are not in view. The need to actuate the joystick into the opposite direction of the turn to move the wheels to a center position is even more frustrating to a novice vehicle operator who is familiar with the steering characteristics of an automotive vehicle in which the vehicle wheels tend to straighten when letting up on the steering wheel.

### SUMMARY

A steering system and method are provided in which the system recognizes a turn request and a return to center request. When the operator moves the joystick to one side or the other, a turn request is indicated. The steering angle may be increased at a predetermined rate in response to a turn request. That is, the steering angle is not proportional to the displacement of the joystick from the center position, but is instead proportional to the length of time that the operator maintains the joystick in one of the side positions. The steering angle continues to increase while the operator maintains the joystick in the side position until encountering a steering limit.

When the operator is no longer pressing the joystick to one side or the other, the joystick returns to a center position, possibly under spring control. According to one embodiment, this is interpreted as a return to center request. For a return to center request, the wheels are not immediately snapped into a center (straight ahead) direction, but are instead gradually returned to a center position in such a way that the direction that a virtual wheel is pointing at the time of the return to center request is detected remains constant throughout the return to center operation. The virtual wheel is an imaginary wheel which can be considered to be located between a pair of steered wheels. The direction of the virtual wheel is indicative of steering angles of the steered wheels. According to Ackerman steering principles, which will be discussed in regards to FIGS. 2A-2C, inside turning wheels have a greater steering angle than outside turning wheels because the diameter circle that the wheels travel through in a turn is different.

An advantage is that the steering more closely mimics that of an automotive vehicle. This makes certain maneuvers easier to negotiate. Furthermore, it is easier for a novice vehicle operator to obtain a facility in driving the vehicle into a desired location by a steering algorithm according to an embodiment of the present disclosure. Steering according to embodiments described in the disclosure can be used in place of prior art methods. In some embodiments, an operator can choose, via a switch or other selection device, to steer according to embodiments described herein or using prior art methods. The operator's choice may depend on the type of maneuver anticipated. The embodiments according to the disclosure are particularly useful in aligning such a vehicle adjacent a wall or other surface.

### BRIEF DESCRIPTION OF THE DRAWINGS

FIG. 1 is a schematic of a vehicle;

FIGS. 2A-2C illustrate Ackerman steering principles for a two-wheel, front-wheel steered vehicle, a two-wheel, rear-wheel steered vehicle, and a four-wheel steered vehicle;

FIG. 3 is an illustration of a trajectory of a vehicle steered according to an embodiment of the disclosure;

FIG. 4 is a flowchart indicating one embodiment for controlling turning movement of a vehicle; and

FIGS. 5 and 6 are sketches of Ackerman steering for two-wheel steer and four-wheel steer examples.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for explanation. However, various combinations and modifications of the features consistent with the teachings of the present disclosure may be desired for particular applications or implementations. The representative embodiments used in the illustrations relate to interpreting an operator request via a joystick, or other controller, in regards to a request to turn or return to center. Those of ordinary skill in the art may recognize similar applications or implementations consistent with the present disclosure, e.g., ones in which components are arranged in a different order than shown in the embodiments in the Figures. Those of ordinary skill in the art will recognize that the teachings of the present disclosure may be applied to other applications or implementations.

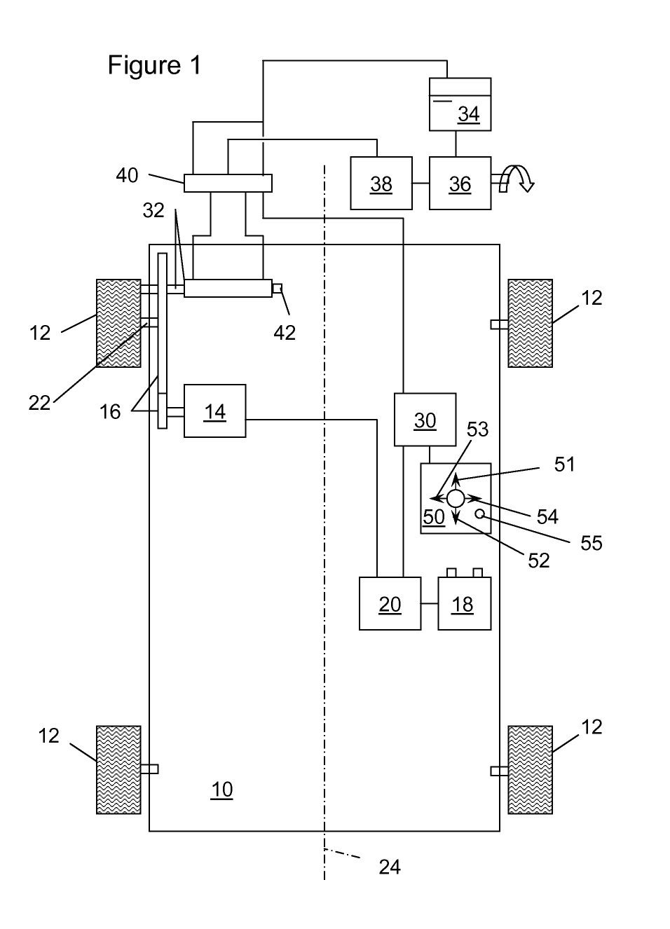

In FIG. 1, a vehicle 10 is shown with a wheel 12 at each corner of vehicle 10. For ease in illustration, the detail of the assemblies coupled to the wheels 12 is shown for only one wheel. Rotational force is applied to wheel 12 by an AC motor 14 coupled to wheel 12 via a reduction gear set 16. AC motor 14 is coupled to battery pack 18 via power electronics 20. The power supplied to AC motor 14 is managed by power electronics 20 based on a signal from an electronic control unit (ECU) 30. AC motor 14 is one non-limiting example for applying torque to wheel 12. Wheel 12, in an alternative embodiment, is rotated via a hydraulic motor. In yet another alternative, wheel 12 is rotated via an internal combustion engine. Wheel 12 is coupled to reduction gear set 16 via an axle 22. Incorporated in this axle is a constant velocity joint, which permits wheel 12 to turn with respect to vehicle 10.

Continuing with FIG. 1, wheel 12 is also provided with a steering apparatus. In one embodiment, the steering angle of wheel 12 is controlled by a hydraulic cylinder 32. In a central position, the direction of wheel 12 is parallel to a longitudinal axis 24 of vehicle 10. Hydraulic cylinder 32 is part of a hydraulic circuit having a reservoir 34 of hydraulic fluid, a hydraulic pump 36, an accumulator 38, and a spool valve 40. Parts of the hydraulic circuit are shown outside the boundary of vehicle 10 for schematic convenience, but are onboard vehicle 10 in most applications. When pump 36 is rotated by an electric motor or other rotational power source, fluid is drawn from reservoir 34, pressurized and supplied to accumulator 38. Spool valve 40 is coupled to the high pressure accumulator and low pressure reservoir 34. Depending on the position of spool valve 40, high pressure fluid can be supplied to one end of hydraulic cylinder 32 (e.g., left end of hydraulic cylinder 32 of FIG. 1) which causes a piston within hydraulic cylinder 32 to retract, thereby pulling the front of wheel 12 toward the right. At a different position of spool valve 40, high pressure fluid is supplied to the right end of hydraulic cylinder 32 which causes the piston within hydraulic cylinder 32 to extend, which moves the front end of wheel 12 toward the left. Hydraulic fluid leakage past sealing surfaces in spool valve 40 and hydraulic cylinder 32 is relieved to reservoir 34 through spool valve 40. The position of spool valve 40 is managed by ECU 30.

ECU 30 may include various components supportive of data processing and system control. For example, ECU 30 may include at least one processor, data storage, memory, bus, signaling interface, network interface, power supply, user interface and the like. In general, ECU 30 is equipped to execute machine readable instructions supplied on machine readable media (from at least one of an internal source and an external source), and to provide output from the execution to users, operators, and components of the vehicle 10. Operation of ECU 30 may therefore include, without limitation, performing a calculation, determination, estimation, referencing, look-up, interpolation, extrapolation, communication and the like.

The wheel steering assembly may be equipped with a sensor from which wheel angle can be determined. In the embodiment shown in FIG. 1, a position sensor 42 on hydraulic cylinder 32 provides a signal to ECU 30, from which steering angle of wheel 12 can be determined based on the extension of hydraulic cylinder 32. Alternatively, an angle sensor can be applied to wheel 12. Any known method to determine the angle of wheel 12 can be used. Alternatively, position of the wheel is based on the commands to hydraulic cylinder 32

In one embodiment, a four-wheeled vehicle is equipped with four each of: reduction gear set 16, AC motor 14, hydraulic cylinder 32, spool valve 40, and position sensor 42. Battery 18 can be shared among four wheels, groups of wheels, or individually. Pump 36, reservoir 34, and accumulator 38 may be shared among all wheels. In an alternate embodiment, only one hydraulic cylinder is provided per pair of steered wheels, e.g., the front wheels, with the two wheels connected by a linkage (not shown in FIG. 1). In one alternative, only two of four wheels are steered wheels. The number of hydraulic cylinders 32, spool valve 40, etc. is reduced in these alternative embodiments. In yet another embodiment, the vehicle is a three-wheeled vehicle with only one steered wheel. Continuing to refer to FIG. 1, operator commands are input via a joystick 50 coupled to ECU 30. Fore 51 and aft 52 directions indicate a desire to move forward or rearward, respectively. In one embodiment, the demanded forward or reverse velocity is proportional to the distance that the joystick is operated fore or aft, respectively. Joystick 50 can also be moved side to side, i.e., toward the left 53 or right 54 to indicate a desire to turn. According to an embodiment of the present disclosure, joystick 50 has a center detent position, which may be interpreted as an operator command to return to center, as will be discussed in more detail below. In alternative embodiments, other types of user-operated input devices or controllers can be used in place of or in combination with joystick 50. For example, in regards to the side-to-side movement to indicate a desire to turn, a 3-position switch could be used. Joystick 50 is shown onboard vehicle 10 in FIG. 1. Alternatively, joystick 50 is onboard a detachable or remote control panel which is coupled to vehicle 10 via a cable. In one embodiment, an operator of the vehicle walks beside the vehicle while holding and actuating the control panel. In yet another embodiment, joystick 50 communicates with ECU 30 wirelessly via any known protocol, e.g., Bluetooth or Wi-Fi.

In yet another embodiment, joystick 50 has a turning rate controller 55. By actuating controller 55, the operator of vehicle 10 selects a desired rate that the steered wheels are turned during turn requests.

In the embodiment shown in FIG. 1 in which AC motor 14 provides rotational force to wheel 12, the rotational speed of wheel 12 can be determined with a high degree of accuracy based on the input to AC motor 14 and the gear ratio of gears 16. In alternative embodiments, such as a hydraulic motor or an internal combustion engine, a speed sensor can be provided on wheel 12 and the signal from wheel 12 provided to ECU 30 to determine wheel rotational speed. From wheel rotational speed, translational velocity at the wheel can be determined knowing the diameter of the wheel (outside diameter of the tire mounted on the wheel, tire not shown separately in FIG. 1). To avoid rubbing the tires, rather than rolling the tires, when the vehicle is undergoing a turn, the velocities at each wheel depends on the distance from the center of the turn radius. A velocity representative of the vehicle can be estimated based on the translational velocities and steering angles of the wheels.

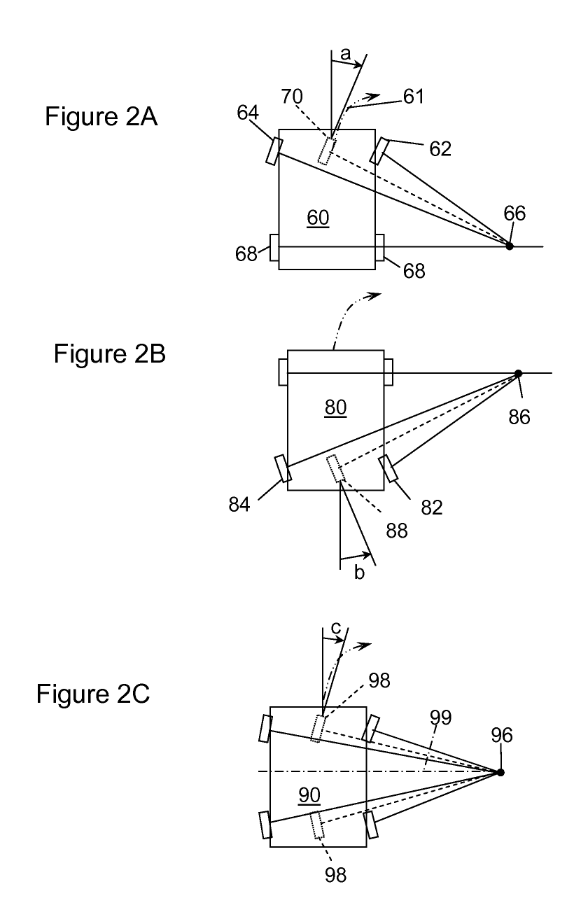

In FIG. 2A, a vehicle 60 is shown undergoing 2-wheel, front-wheel steering toward the right, as indicated by dash-dot-dot arrow 61. For this right hand turn, according to Ackerman steering principles known to one skilled in the art, wheel 62, the inside front wheel, is turned at a tighter angle than wheel 64, the outside front wheel, to account for wheel 62 negotiating a tighter radius turn than wheel 64. An axis of rotation of the non-steering wheels 68, an axis of rotation of wheel 62 and an axis of rotation of wheel 64 intersect at a turning center 66 (alternatively can be called the “Ackerman center point”). Vehicle 60 rotates about turning center 66. A steering angle, a, of a virtual wheel 70 located between wheels 62 and 64 can be defined. Virtual wheel 70 is a conceptual wheel that is used for control and computation purposes. Virtual wheel 70 can be used to represent a steering angle, for example, for the entire vehicle. From the steering angle for the virtual wheel 70, steering angles for all steered wheels on the vehicle can be computed. In one embodiment, a steering angle is computed for virtual wheel 70. Based on the position of wheels 62 and 64 with respect to virtual wheel 70, steering angles for wheels 62 and 64 can be computed.

In FIG. 2B, two-wheel, rear-wheel steering is shown for a vehicle 80 in which wheels 82 and 84 are steered wheels. A line drawn through the axles of the front wheels, a line drawn through the axle of wheel 82, a line drawn through the axle of wheel 84, and a line drawn through the axle of virtual wheel 88 intersect at turning center 86. Virtual wheel 88 is located between steered wheels 82 and 84 and substantially in a plane formed by the vehicle wheels.

In FIG. 2C, four-wheel steering is shown for a vehicle 90. Lines drawn through the axles of all the wheels of vehicle 90 intersect at turning center 96. A virtual steering angle, c, can be computed for virtual wheel 98, which can considered to be located either between the front or rear wheels. The virtual steering angle is a single angle used to represent the steering angle of the vehicle. From the virtual steering angle, steering angles for all the wheels can be computed, based on their position with respect to virtual wheel 98. In FIG. 2C, a virtual wheel is shown both in between the front wheels and rear wheels of the vehicle. Either location of virtual wheel can be used. The virtual wheel can be considered to be located anywhere, except on dash-dot line 99 (dash-dot line 99 is a line perpendicular to the longitudinal axis of vehicle 90 and crossing through turning center 96), as a virtual wheel with its axis collinear with dash-dot line 99 would have no steering angle. Thus, there would be no steering angle from which to compute the steering angles for the four steered wheels. Similarly for FIGS. 2A and 2B, the virtual wheel can be located at a different location than shown, 70 and 88, respectively. However, the virtual wheel cannot be located between non-steered wheels 68, in the front wheel steering example of FIG. 2A or in between non-steered wheels (front) wheels of FIG. 2B. In one embodiment, the virtual wheel is placed coincident with one of the actual steered wheels. It may be useful for the operator of the vehicle to use the actual wheel to aid in directing the vehicle via the joystick. In one example, the actual wheel used as the virtual wheel is a wheel that is in the line of sight of the vehicle operator. In another alternative, the virtual wheel is defined to be an inside turning wheel. In such an embodiment, the virtual wheel changes location depending on whether the turn is a right hand turn or a left hand turn.

As described above, steering angles are computed for all the steered wheels based on the steering angle of the virtual wheel and the location of the steered wheel with respect to the virtual wheel. Additionally, rotational speeds are computed for each of the wheels. For the turn shown in FIG. 2A, wheel 64 travels along a larger diameter circle than wheel 62. To avoid tire rub, ECU 30 commands the AC motor coupled to wheel 64 to rotate at a higher speed than wheel 62. Similarly, the left one of wheels 68 travels on a circle of a larger diameter than the right one of wheels 68. To smoothly negotiate the turn, each of the AC motors coupled to wheels 68 is commanded to rotate at a speed appropriate for the path that the wheel is commanded to travel. As with virtual steering angle, in which a single angle is used to represent a steering angle for the vehicle, a vehicle velocity is defined. A single value, vehicle velocity, is used to represent velocity of the vehicle as a whole with the understanding that when undergoing a turn, some corners of the vehicle travel faster than the vehicle velocity while other corners of the vehicle travel slower than the vehicle velocity.

The vehicle operator communicates the desire for forward velocity, rearward velocity, left turns, and right turns through joystick 50. The forward or rearward velocity may be proportional to the displacement of joystick 50 in a fore or aft direction, respectively, from a neutral position.

In one embodiment, the left-right movement of joystick 50 has three positions: left 53, right 54, and center. In response to a request to the switch being in a left position, the virtual steering angle increases to the left at a predetermined rate. Thus, if the operator maintains the joystick in the left position 53, the steered wheels continue to be turned toward the left at the predetermined rate until reaching the steering angle limit, either a hardware or software limit, or until the operator stops pushing joystick 50 toward the left 53. When the vehicle operator ceases pushing joystick 50 either right 54 or left 53, joystick 50 returns to the center position, possibly under spring control, to a detent position. According to an embodiment of the disclosure, when joystick 50 is in the center position, a return to center routine is initiated in which the wheels are turned back to their center position, i.e., directed straight forward, in such a manner that the direction that the virtual wheel is pointing remains constant.

According to one embodiment, an angular velocity, omega_v, of the vehicle is estimated based on vehicle velocity and the virtual steering angle. So that the virtual wheel remains pointing in the same direction during the return to center routine, the virtual wheel steering angle changes so that the angular velocity of the virtual wheel (with respect to the vehicle) is -omega_v. The steering angles of the steered wheels of the vehicle are computed from the virtual steering angle and based on the position of the steered wheel from the virtual wheel. The example just discussed is for a vehicle driving forward with front wheel steer. For the same vehicle driving in reverse, the resulting angular velocity is omega_v and the virtual wheel is rotated in the same direction as the vehicle is currently rotating for the vehicle to return to center.

The appropriate sign to apply to omega_v for the virtual wheel can be computed for all examples of front wheel, rear wheel, and four-wheel steer and for both forward and reverse movement. An alternative is to apply the magnitude of omega_v to determine a new angle with the knowledge that when returning to center, the virtual wheel moves toward a zero steering angle in all cases. For example, if the virtual wheel is determined to be rotated clockwise, upon receiving a request for a return to center, the virtual wheel is rotated counterclockwise at a rate based on omega_v.

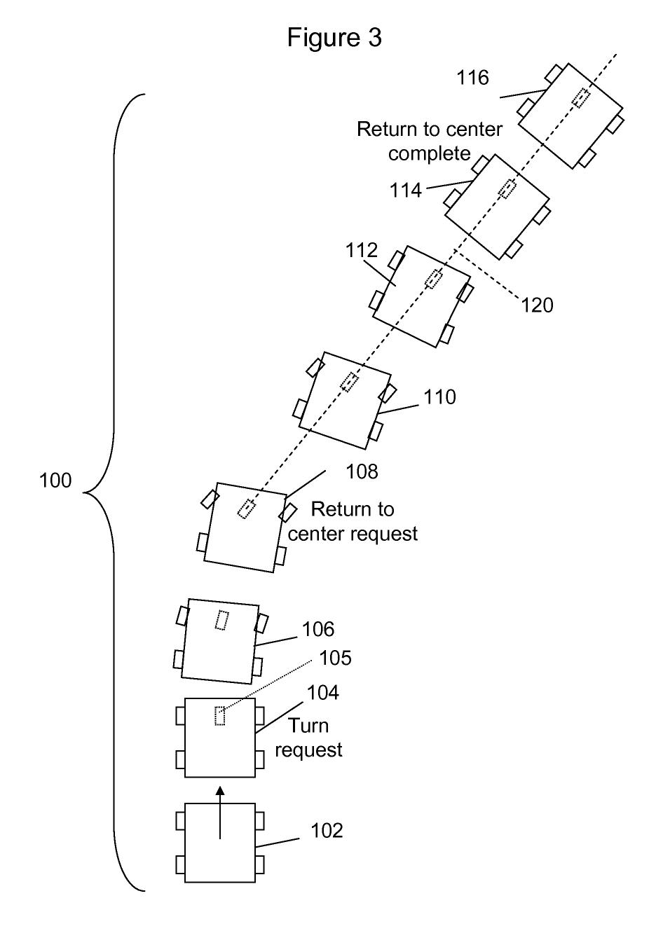

Snapshots 100 of the resulting trajectory of a four-wheel, front-wheel steered vehicle, moving according to embodiments of the present disclosure, are shown in FIG. 3. The vehicle is moving straight ahead in 102. At 104, the operator moves the joystick to the right to indicate a desire to turn. In response to the turn request, ECU 30 determines a virtual steering angle for a virtual wheel 105 (shown as a dotted wheel in each of snapshots 104, 106, 108, 110, 112, 114, and 116) located at the center between the two front wheels. The actual steering angles for the two steered wheels are computed based on their distance away from the virtual wheel. The Ackerman steering equation is known by one skilled in the art to be:

cot(a_{—}o)−cot(a_{—}i)=t/l, where
a_i is the steering angle of the inner wheel (i.e., the wheel nearer the turning radius),
a_o is the steering angle of the outer wheel;
t is track width, i.e., the distance between the outer and inner wheels or lateral wheel separation; and
l is wheelbase, i.e., the distance between the front wheels and the rear wheels or longitudinal wheel separation.

The equation above is provided in terms of actual wheels, inner and outer. The equation can be recast for a virtual wheel:

cot(a_{—}o)−cot(a_{—}v)=t_{—}vo/l_{—}vo, when the virtual wheel is inboard with respect to the actual wheel or

cot(a_{—}v)−cot(a_{—}i)=t_{—}vi/l_{—}vi, when the virtual wheel is outboard with respect to the actual wheel, where
t_vo and t_vi are the lateral wheel separations between the virtual wheel and the outer and inner wheels, respectively; and
l_vo and l_vi are the lateral wheel separations between the virtual wheel and the outer and inner wheels, respectively.

The Ackerman angles for a four-wheel steering situation is determined analogously: cot(a_o)−cot(a_i)=2t/l for wheels proximate the end of the vehicle in the direction of travel (front wheels for this Ackerman discussion). The steering angle for the inner rear wheel is negative that of the inner front wheel and the steering angle for the outer rear wheel is negative of the outer front wheel.

The right front wheel has a greater steering angle than the left front wheel because of the smaller diameter circle it travels in a right turn as shown in snapshot 106. Although not shown in FIG. 3, the operator continues to depress the joystick to the right. In response, the wheels are turned even further to the right in 108. As with snapshot 106, ECU 30 computes a virtual steering angle for the virtual (dotted) wheel located between the steered wheels based on positions of the steered wheels. At 108, a return to center request is received, i.e., the operator ceases pushing the joystick to the right and the joystick returns to the center detent position. The return to center request is interpreted as a desire to straighten out the vehicle travel in the direction that the virtual wheel is traveling at the time that the return to center request is detected. Thus, the virtual steering angle computed at snapshot 108 is known. The direction of the virtual wheel at the time that the return to center request is received is indicated by dashed line 120 in FIG. 3. Because the wheels are pointing toward the right, the vehicle turns to the right between snapshot 108 and snapshot 110. A vehicle angular velocity, omega_v, (units of degrees/sec or radians/sec) can be computed based on the vehicle forward velocity and the virtual steering angle. For the direction of the virtual wheel to remain constant, the virtual wheel has an angular velocity that is equal and opposite to the vehicle angular velocity, i.e., -omega_v. A new virtual steering angle is computed for the virtual wheel so that it achieves an angular velocity of -omega_v (the wheel is turned with respect to the vehicle at -omega_v, but the vehicle is rotating at omega_v; consequently, the angle of the virtual wheel with respect to the ground remains constant). ECU 30 computes the steering angles for each of the steered wheels from the virtual steering angle which is then used to direct/move the steered wheels. Thus, in 110, the wheels are turned to a lesser steering angle than in 108 in such a manner that the virtual wheel is turning at -omega_v (with respect to the vehicle). The direction of travel of the virtual wheel in 110 is coincident with dashed line 120. A new vehicle angular velocity, omega_v, is calculated for the condition at 110. New steering angles are computed for the steered wheels and the wheels are commanded to the new steering angles in 110. The return to center continues, until in 114, the wheels are all aligned to their center position and the vehicle moves straight forward. The algorithm computing vehicle angular velocity and a new virtual steering angle continues, according to an embodiment of the disclosure. However, if no turn request is received, the vehicle angular velocity is zero while moving straight forward; consequently, there is no further adjustment in steering angle. During the return to center operation, i.e., 108 to 114, the vehicle straightens out in the direction of the virtual wheel at the time that the return to center request was received, i.e., at 108.

During the return to center operation (depicted as 106-112 in FIG. 3), the virtual wheel maintains a constant direction, thus does not rotate with respect to the ground on which the vehicle is traveling. Because the vehicle is rotating to the right at omega_v, the virtual wheel rotates to the left at -omega_v, with respect to the vehicle, to maintain its constant direction. Thus, the -omega_v rotation of the virtual wheel is with respect to the vehicle, not with the ground.

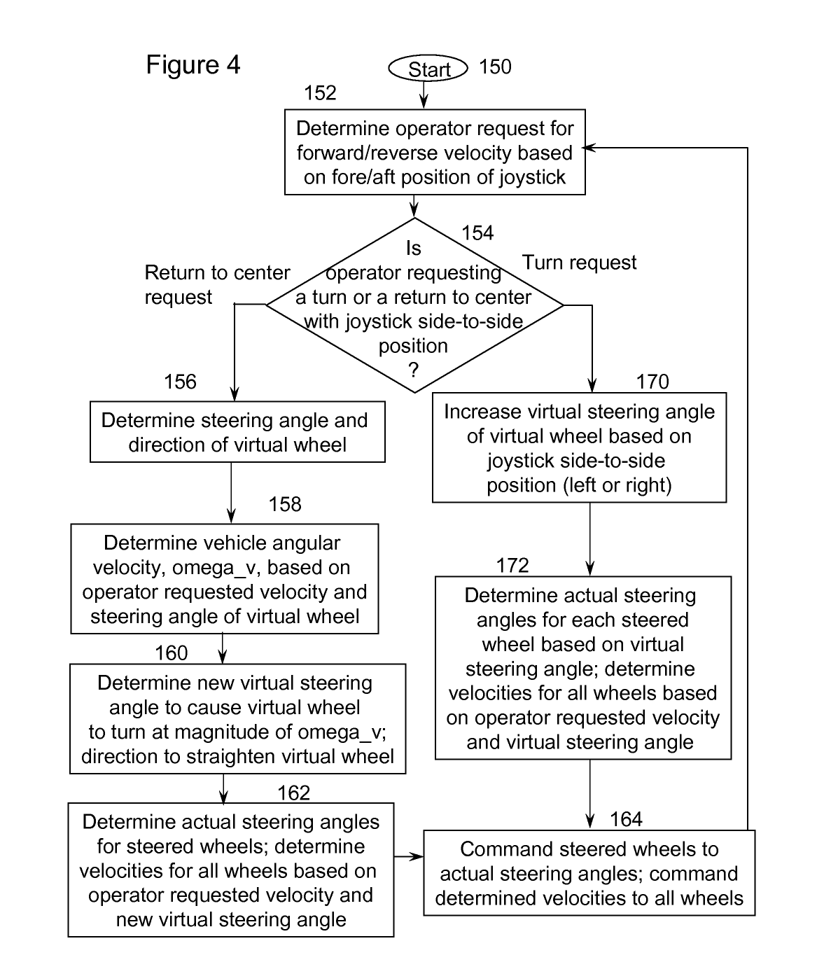

A flowchart depicting an embodiment of the disclosure is presented in FIG. 4. The algorithm starts in block 150. The operator of the vehicle requests a forward (or reverse) velocity of the vehicle by pushing joystick 50 in a fore 51 (or aft 52) direction. The magnitude of the velocity requested is roughly proportional to the fore (or aft) distance of joystick 50 from a central or neutral position. In block 152, the operator request for forward (or reverse) velocity is determined from the joystick fore (or aft) position. Control passes to block 154, in which it is determined whether the operator of the vehicle is requesting a turn (right or left) or a return to center. If a return to center is requested, control passes to block 156 in which the present direction and steering angle of the virtual wheel is determined. The present steering angle for the virtual wheel can be computed based on steering angles of the steered wheels by a geometric computation. The steering angles of the steered wheels are known based on: output of a position sensor on each of the steered wheels (if the vehicle is so equipped), having a position sensor on one of the steered wheels with a known relationship between the angles of the steered wheels, by piston position of hydraulic cylinder 32, and/or by keeping track of the commanded steering changes to the steered wheels. The position sensor can be based on the piston position of hydraulic cylinder 32, in one embodiment. Control passes to block 158 in which a vehicular angular velocity, omega_v, and velocity of the vehicle are determined. If there is no virtual steering angle (i.e., it is zero) or if the vehicle velocity is zero, then omega_v is zero. Control then passes to block 160 in which a new virtual steering angle is computed so that the virtual wheel turns at an omega_v, i.e., the magnitude of the rotation applied to the virtual wheel is omega_v. The direction of the rotation of the virtual wheel is to cause it to move toward its center position or zero steering angle, i.e., straight ahead. That is, if the virtual wheel is presently in rotated counterclockwise, the direction of rotation of the virtual wheel, upon a return to center request, is clockwise. In block 162, from the new virtual steering angle, actual steering angles for the steered wheels can be computed. Also, velocities for all the wheels are determined based on the operator requested velocity and the new virtual steering angle. That is, depending on the diameter of the circle that the various wheels follows at the present steering angle, the velocities of each wheel is individually computed. Finally in block 164, the actual steering angles are commanded to ?the steered wheels and the determined velocities are commanded to each wheel.

Continuing to refer to FIG. 4, if a turn request is received in block 154, control passes to block 170 in which the virtual steering angle of the virtual wheel is increased. The virtual steering angle increases at a predetermined rate as long as the joystick is maintained in the same side-to-side position (left or right). The virtual steering angle stops increasing when: 1) the operator stops pushing the joystick; 2) the operator pushes the joystick to the opposite side-to-side direction; 3) the actual wheels hit a hardware limit; or 4) the virtual steering angle hits a software limit. In block 172, the actual steering angle for the steered wheels is determined from the virtual steering angle of block 170. Also in block 172, the velocities for each wheel are determined based on the operator requested velocity and the virtual steering angle. Control then passes to block 162 in which the determined velocities and steering angles are commanded to the appropriate wheels. From block 162, control passes back to block 152 in which the present operator request for forward/reverse velocity is detected based on joystick fore/aft position.

The flowchart in FIG. 4 represents processes conducted in a microprocessor or other controller. The rate at which the loops are conducted depends on the processor speed and other computations that are being performed concurrently.

However, it is expected that commands to the wheels, as in block 164, occur more than once per second and likely more frequently.

The flowchart in FIG. 4 represents one non-limiting exemplary embodiment. For example, some operations can be performed in a different order than shown in FIG. 4.

Vehicle velocity may be accurately estimated based on an input to AC motors. However, in one alternative, speed sensors are provided at each wheel to determine wheel speed.

As described in conjunction with FIG. 4, all wheels are described as driven wheels. Alternatively, only one or two wheels are coupled to a power source, such as an electric motor, an internal combustion engine, or a hydraulic motor. In such a configuration, non-driven wheels simply rotate freely, but provide no motive force to the vehicle. No velocities are computed for such non-driven wheels.

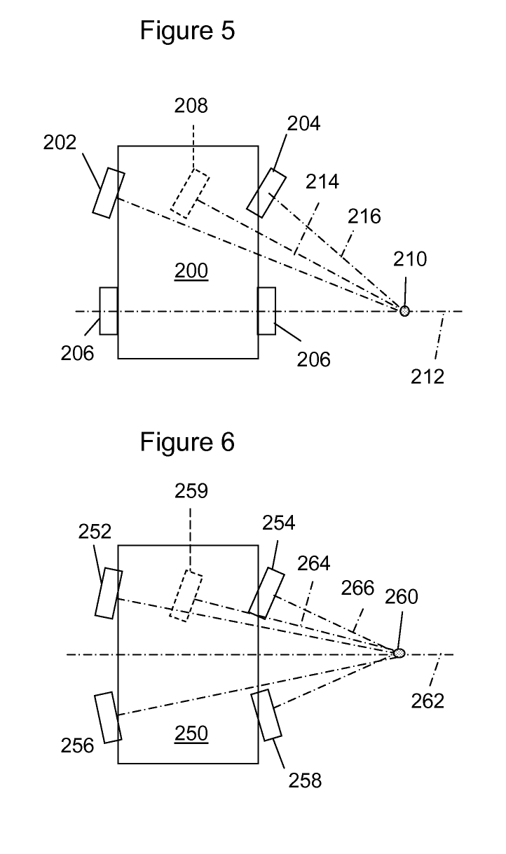

In FIG. 5, a two-wheel steer vehicle 200 is shown having left and right steered wheels 202 and 204, respectively, and rear wheels 206. Also shown is a virtual wheel 208 in between wheels 202 and 204. As described above, the virtual wheel 208 can be located almost anywhere with respect to the vehicle, but in the plane of the actual wheels. A turn center 210 is the center of rotation of vehicle 200. This is located at the intersection of a line 212 parallel to the axes of rotation for wheels 206 (perpendicular to their direction of travel) and a line 214 which is parallel to the axis of rotation for virtual wheel 208 (perpendicular to the virtual wheel's direction of travel). A line 216 is drawn from turn center 210 to the axis of steered wheel 204. The appropriate angle for steered wheel 204, so that steered wheel travels around the turn with turn center 210 without dragging the wheel, is one in which the travel direction of wheel 204 is substantially perpendicular to line 216 (axis of wheel 204 is substantially parallel with line 216). In an analogous manner, a turning angle for wheel 202 is also determined. Wheel 202 is turned at a lesser angle from its center position than wheel 204 because it turns through a greater radius circle than wheel 204 when making a right turn.

The velocity calculated for each of the respective steered wheels 202, 204, is dependent upon the relative distance from turn center 210, i.e., the length of the arc that each wheel will travel. Accordingly, the motive force for an outer steered wheel (in this case, steered wheel 202), will be slightly greater than the motive force for the inner steered wheel 204.

In FIG. 6, a four-wheel steer vehicle 250 is shown in which all wheels 252, 254, 256, and 258 are steered. Virtual wheel 259 is shown located between wheels 252 and 254, but this is simply one exemplary location. A turn center 260 is located on an axis 262, which is perpendicular to the longitudinal axis of vehicle 250. The axis of virtual wheel 259 also crosses through turn center 260. The steering angle for wheel 252 is determined such that axis 262 is both perpendicular to the direction of travel of wheel 252 as well as intersects turn center 260. The steering angles for wheels 254, 256, and 258 are similarly determined. Although only briefly described here, Ackerman steering principles are well known to one skilled in the art.

While the best mode has been described in detail, those familiar with the art will recognize various alternative designs and embodiments within the scope of the following claims. For example, the disclosed method and system can be used in a 2-wheel steering mode or a 4-wheel steering mode. Also, industrial vehicles are mentioned in the disclosure. However, this is a non-limiting example, as the disclosure can be applied to any type of steered vehicle. Where one or more embodiments have been described as providing advantages or being preferred over other embodiments and/or over prior art in regard to one or more desired characteristics, one of ordinary skill in the art will recognize that changes, additions, or compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. As an example, for cost reasons, a steering apparatus may be provided on two of the four wheels, in some applications. The embodiments described as being less desirable relative to other embodiments with respect to one or more characteristics are not outside the scope of the disclosure as claimed.

What is claimed:

1. A method for steering a vehicle, comprising:
detecting a return to center request;
determining a virtual steering angle when the return to center request is detected;
determining a vehicle velocity;
determining a new virtual steering angle based on the virtual steering angle and the vehicle velocity;
determining a steering angle for each steered wheel coupled to the vehicle, each steering angle based on the new virtual steering angle; and
commanding each steered wheel to the respective steering angle

2. The method of claim 1, wherein the virtual steering angle is based on a virtual wheel of the vehicle and is determined based on an angle between a direction that the virtual wheel is pointing and a longitudinal axis of the vehicle.

3. The method of claim 2 wherein the steering angles are further based on a position of the steered wheels with respect to a position of the virtual wheel.

4. The method of claim 2, further comprising:
determining a vehicle angular velocity based on the vehicle velocity and the virtual steering angle wherein the new virtual steering angle is determined so that an angular velocity of the virtual wheel with respect to the vehicle substantially equals a negative of the vehicle angular velocity.

5. The method of claim 1, further comprising:
detecting a turn request;
increasing a turning virtual steering angle at a predetermined rate during the turn request;
determining a steering angle for each of the steered wheels based on the turning virtual steering angle; and
commanding steered wheels coupled to the vehicle to assume the steering angles.

6. The method of claim 1 wherein the vehicle has at least one steered wheel and two non-steered wheels, the virtual wheel is coincident with one of the at least one steered wheels and the steering angle for one steered wheel is equal to the determined new virtual steering angle.

7. The method of claim 1 wherein the return to center request is detected when a steering input device is centered in between a left and right position.

8. The method of claim 1 wherein the new virtual steering angle is closer to a zero angle than the determined virtual steering angle and the zero angle is one in which a direction of travel of the virtual wheel is parallel with a longitudinal axis of the vehicle.

9. The method of claim 1 wherein the steering angles for steered wheels are based on Ackerman steering principles computed based on the new virtual steering angle.

10. A computer usable medium having a computer readable program code embodied therein, the computer readable program code adapted to be executed to implement a method for controlling a vehicle, comprising instructions for:
detecting a return to center request; and
commanding each steered wheel coupled to the vehicle to return to a center position in response to the return to center request wherein return to the center position of the wheels is commanded so as to substantially maintain the direction that a virtual wheel is pointing at the time that the return to center request is detected.

11. The computer usable medium of claim 10 wherein the vehicle has four wheels, two of the four wheels are steered wheels, two of the wheels are non-steered wheels, and the virtual wheel is one of: a left one of the steered wheels, a right one of the steered wheels, an imaginary wheel located in between the two steered wheels, and an imaginary wheel located elsewhere except along the axis of the two non-steered wheels.

12. The computer usable medium of claim 10, wherein commanding steered wheels further comprises instructions for:
determining a vehicle velocity;
determining a vehicle angular velocity based on a steering angle of the virtual wheel and the vehicle velocity;
determining a new virtual steering angle so that the virtual wheel turns, with respect to the vehicle, at an angular velocity substantially equal to the vehicle angular velocity in a direction that causes a direction of travel of the virtual wheel to more closely align with a longitudinal axis of the vehicle;
determining a new steering angle for each steered wheel coupled to the vehicle based on the new virtual steering angle; and
commanding each steered wheel to assume the new steering angle determined for each steering wheel.

13. The computer usable medium of claim 10 wherein the return to center request is determined based on an operator-controlled input device coupled to the vehicle.

14. The computer usable medium of claim 13 wherein the operator-controlled input device in one of: a joystick, a switch, a remote control panel, and a wireless input device.

15. The computer usable medium of claim 13, further comprising:
detecting an operator request for vehicle velocity based on a fore/aft position of the operator-controlled input device; and
determining a rotational speed for each wheel coupled to the vehicle based on the vehicle velocity request, a steering angle of the virtual wheel, and the relative position of each wheel with respect to the virtual wheel.

16. A system for steering a vehicle, comprising:
wheels coupled to the vehicle with at least one of the wheels being a steered wheel;
a steering apparatus coupled to the at least one steered wheel, the steering apparatus adapted to turn the at least one steered wheel;
an operator-input device coupled to the vehicle, the operator-input device having a turn request position and a return to center position;
an electronic control unit in communication with the operator-input device, the vehicle, and the steering apparatus, the electronic control unit: determining the present position of the operator-input device and commanding the steering apparatus to turn the at least one steered wheel toward a center position when the operator-input device is in the return to center position wherein the rate of return of the steered wheels to the center position is commanded to maintain a direction of a virtual wheel with respect to ground.

17. The system of claim 16 wherein when the operator-input device is in the turn request position, the electronic unit computes a virtual steering angle such that steering angle increases at a predetermined rate, the electronic control unit computes steering angles for the steered wheel coupled to the steering apparatus based on the virtual steering angle, and the electronic control unit commands the steering apparatus to turn the steered wheels to the computed steering angle.

18. The system of claim 16, further comprising:
a sensor coupled to the steering apparatus and to the electronic control unit wherein a steering angle of one of the steered wheels is determined based on a signal from the sensor.

19. The system of claim 16, wherein the steering apparatus further comprises:
a hydraulic cylinder coupled to one of the steered wheels;
a hydraulic reservoir coupled to the hydraulic cylinder;
a hydraulic pump coupled to the reservoir;
an accumulator coupled to the hydraulic pump; and
a spool valve coupled to the accumulator, the hydraulic cylinder, and the reservoir, the spool valve electronically coupled to the electronic control unit wherein the spool valve controls flow of pressurized hydraulic fluid from the accumulator to the hydraulic cylinder and controls leak flow from the hydraulic cylinder to the reservoir.

20. The system of claim 16, further comprising: an AC motor coupled to each wheel and electronically coupled to the electronic control unit via power electronics wherein the electronic control unit determines a rotational speed for each wheel based on a fore-aft position of the operator-input device, a steering angle of the virtual wheel, and a relative position of each wheel with respect to the virtual wheel and the electronic control unit commands the AC motors to drive the wheels at such rotational speeds.
